(19) United States
(12) Patent Application Publication
(10) Pub. No.: US 2025/0278734 A1
(43) Pub. Date: Sep. 4, 2025

(54) SYSTEMS AND METHODS FOR UTILIZING ARTIFICIAL INTELLIGENCE MODELS TO PREVENT FRAUDULENT ACTIVITIES

(71) Applicant: Verizon Patent and Licensing Inc., Basking Ridge, NJ (US)

(72) Inventors: Dheeraj SINGH, Bareilly (IN); Miruna JAYAKRISHNASAMY, Vellore (IN)

(73) Assignee: Verizon Patent and Licensing Inc., Basking Ridge, NJ (US)

(21) Appl. No.: 18/591,671

(22) Filed: Feb. 29, 2024

(51) Int. Cl. G06Q 20/40

(52) U.S. Cl. CPC G06Q 20/4016

(57) ABSTRACT

A device may receive input data identifying input features associated with a user, and may process the input data, with an initial model, to predict one or more fraud stages for the user. The device may identify one or more sets of models from a plurality of models and based on the one or more fraud stages, and may process the input data, with the one or more sets of models, to determine one or more fraud parameters associated with the user. The device may identify a fraudulent activity associated with the user based on the fraud parameters, and may utilize a large language model to generate steps to resolve the fraudulent activity based on historical fraud resolutions. The device may provide the steps to resolve the fraudulent activity to a representative or the user for implementation.

### BACKGROUND

In the context of technological environments, businesses (e.g., network service providers) are confronted with the challenge of protecting personal and financial customer information against identity theft and other fraudulent activities, such as subscriber identity module (SIM) swapping, account takeovers, unauthorized transactions, and/or the like. Such fraudulent activities are not only detrimental to the customer experience but also pose a substantial risk to businesses, resulting in significant customer losses and erosion of customer trust.

### BRIEF DESCRIPTION OF THE DRAWINGS

FIGS. 1A-1H are diagrams of an example associated with utilizing artificial intelligence (AI) models to prevent fraudulent activities.

FIG. 2 is a diagram illustrating an example of training and using a machine learning

model.

FIG. 3 is a diagram of an example environment in which systems and/or methods described herein may be implemented.

FIG. 4 is a diagram of example components of one or more devices of FIG. 3.

FIG. 5 is a flowchart of an example process for utilizing AI models to prevent fraudulent activities.

### DETAILED DESCRIPTION OF EXAMPLE EMBODIMENTS

The following detailed description of example implementations refers to the accompanying drawings. The same reference numbers in different drawings may identify the same or similar elements.

Current techniques for preventing fraudulent activities rely largely on human intervention and fail to effectively prevent or promptly respond to fraudulent activities. Current fraud prevention systems typically provide reactive responses to fraudulent activities, rather than proactive prevention of fraudulent activities, leaving businesses and customers vulnerable to increasingly sophisticated fraud schemes. Further, these reactive systems provide indications of fraud after the fact making it more difficult to trace or correct. Moreover, reliance on human intervention to detect and resolve fraudulent activities can lead to high call volumes for customer support centers, escalated operational costs, and compounded losses resulting from fraudulent activities. Customer dissatisfaction may escalate quickly when accounts are compromised, leading to higher churn rates and damage to reputations of businesses. The fraudulent activities may be associated with account activation, changes, and charges (e.g., a majority of the fraudulent activities); equipment, order, or device changes; account breach attempts; fraudulent credit inquiries; fraudulent device ports; subscriber identity module (SIM) swaps; identity theft; account takeovers; fraudulent or unauthorized operations; and/or the like.

Thus, current techniques for preventing fraudulent activities consume computing resources (e.g., processing resources, memory resources, communication resources, and/or the like), networking resources, and/or other resources associated with failing accurately identify fraudulent activities, failing to timely identify fraudulent activities, handling increased customer complaints due to fraudulent activities, handling increased operational costs due to fraudulent activities, losing customers due to fraudulent activities, and/or the like.

Some implementations described herein relate to a security system that utilizes AI models to prevent fraudulent activities. For example, the security system may receive input data identifying input features associated with a user, and may process the input data, with an initial model, to predict one or more fraud stages for the user. The security system may identify one or more sets of models from a plurality of models and based on the one or more fraud stages, and may process the input data, with the one or more sets of models, to determine one or more fraud parameters associated with the user. The security system may identify a fraudulent activity associated with the user based on the fraud parameters, and may utilize a large language model to generate steps to resolve the fraudulent activity based on historical fraud resolutions. The security system may provide the steps to resolve the fraudulent activity to a representative or the user for implementation.

In this way, the security system utilizes AI models to prevent fraudulent activities. For example, the security system may enhance and expedite detection and resolution of fraudulent activities using advanced analytical models (e.g., AI models, machine learning models, and/or the like). The security system significantly improves upon current techniques for preventing fraudulent activities by automating the detection of fraudulent activities through utilization of the analytical models. By reducing reliance on manual intervention and accelerating response time to identify and prevent fraudulent activities, the security system may mitigate losses due to fraudulent activities more effectively, may reduce costs, and may enhance the operational integrities of technological environments operated by businesses. Thus, the security system may conserve computing resources, networking resources, and/or other resources that would have otherwise been consumed by failing accurately identify fraudulent activities, failing to timely identify fraudulent activities, handling increased customer complaints due to fraudulent activities, handling increased operational costs due to fraudulent activities, losing customers due to fraudulent activities, and/or the like.

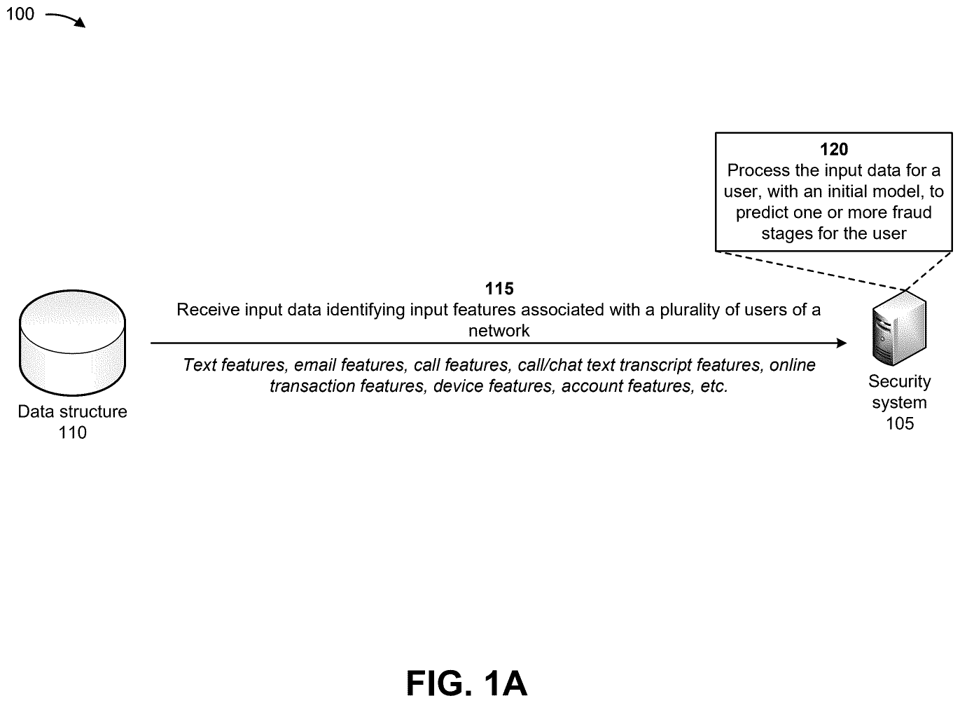

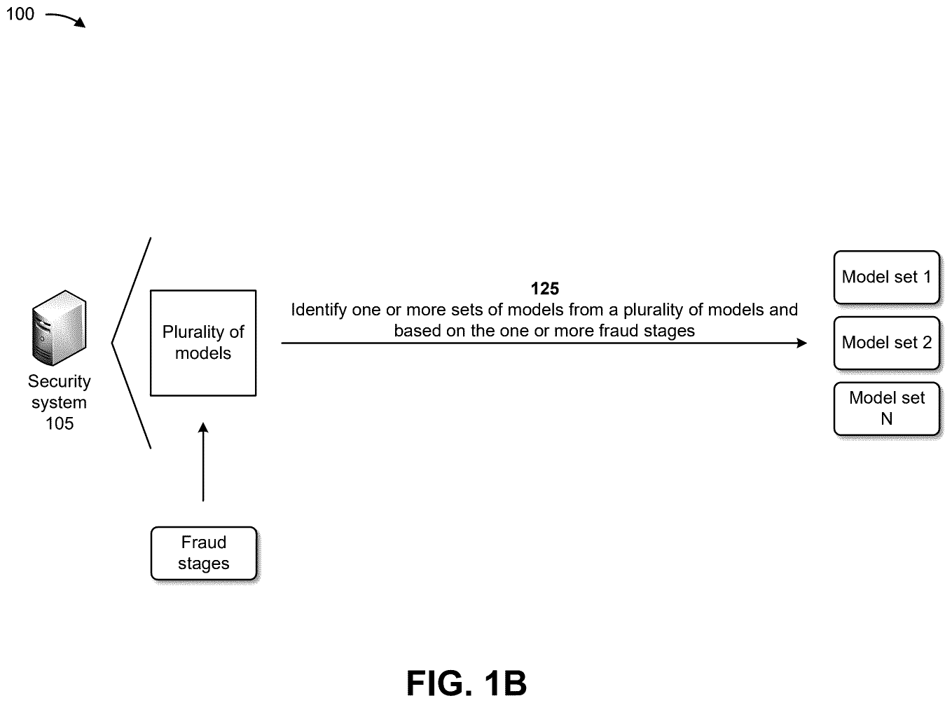

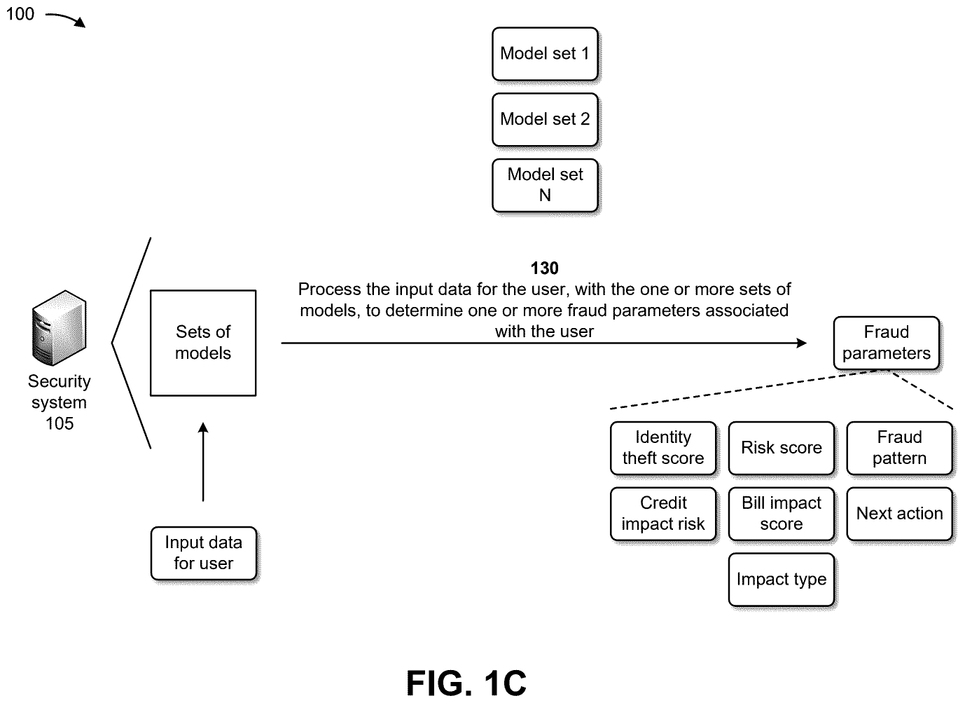

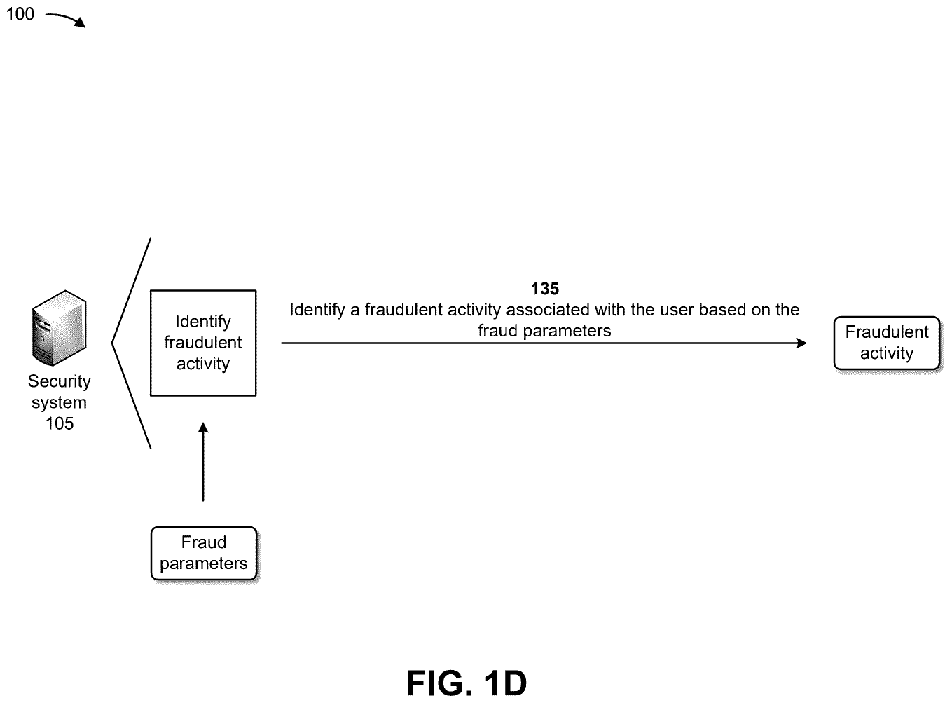

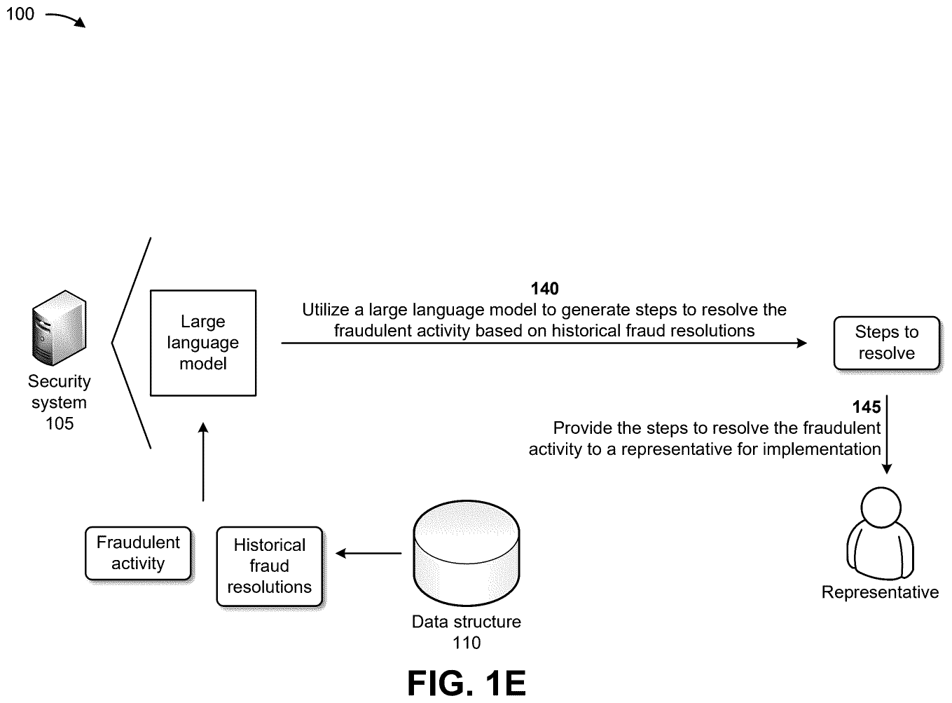

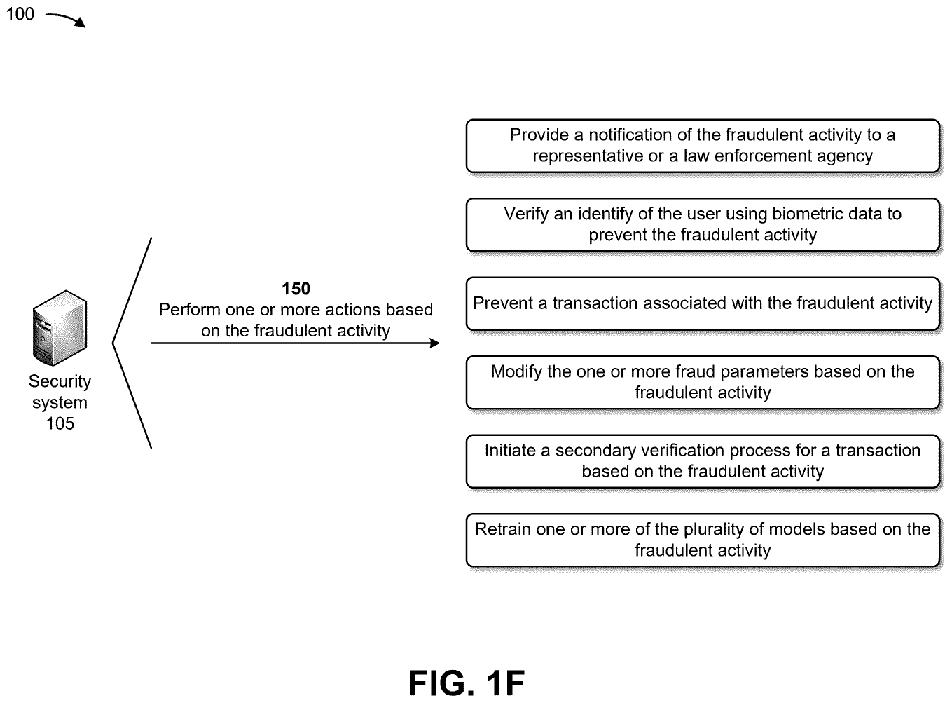

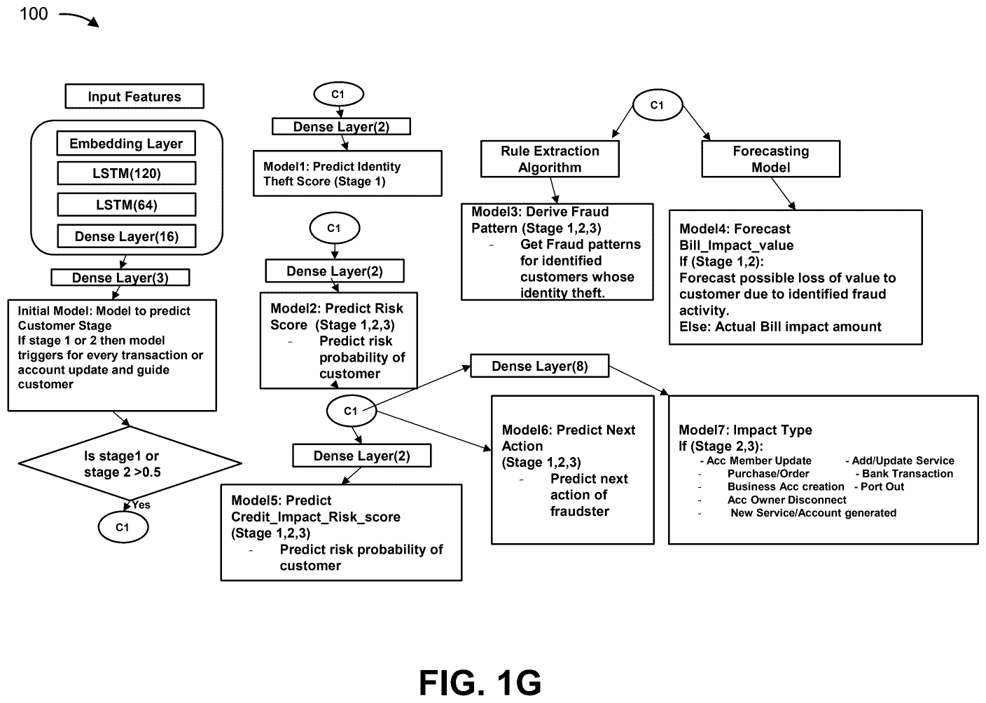

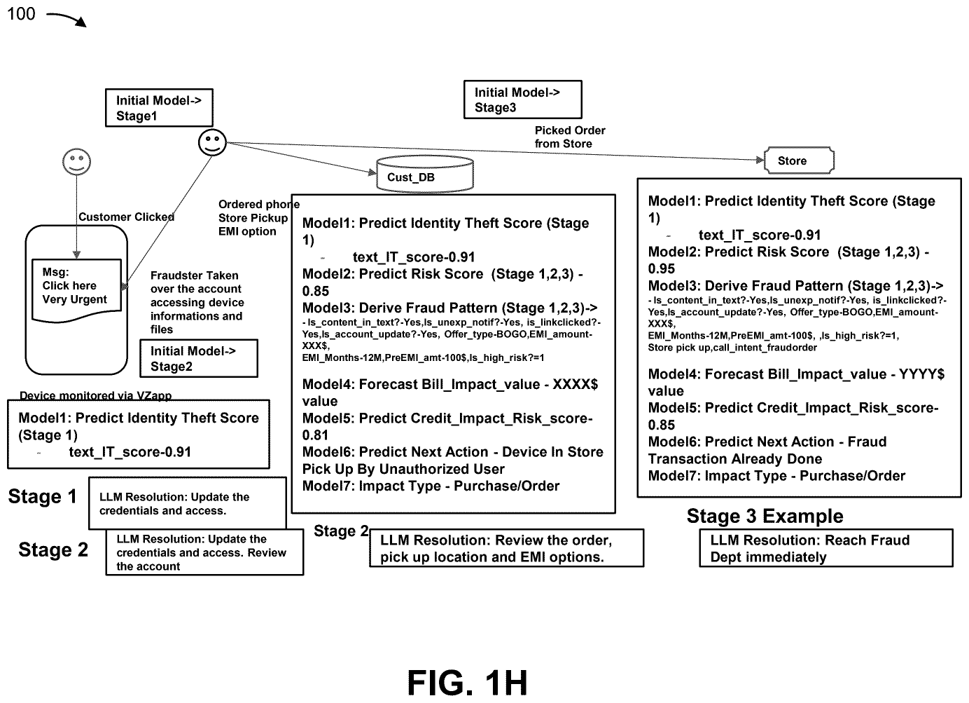

FIGS. 1A-1H are diagrams of an example 100 associated with utilizing AI models to prevent fraudulent activities. As shown in FIGS. 1A-1H, example 100 includes a security system 105 associated with a data structure 110. The security system 105 may include a system that utilizes AI models to prevent fraudulent activities. The data structure 110 may include one or more databases, tables, lists, and/or the like. Further details of the security system 105 and the data structure 110 are provided elsewhere herein.

As shown in FIG. 1A, and by reference number 115, the security system 105 may receive input data identifying input features associated with a plurality of users of a network. For example, a network (e.g., a telecommunications network, an Internet service provider network, and/or the like) may provide a variety of features for a plurality of users of the network, such as text features, email features, call features, identification proof features, call or chat transcripts, transaction features, device features, account features, and/or the like. The network may generate the variety of features and may continuously and/or periodically store the variety of features in the data structure 110 as the input data identifying the input features associated with the plurality of users of the network.

The text features may include features identifying senders of text messages, content of text messages, links in text messages, service provider content in text messages, quantities of text messages, link selections associated with text messages, and/or the like. The email features may include features identifying senders of email messages, subjects of email messages, content of email messages, links in email messages, service provider content in email messages, quantities of email messages, link selections associated with email messages, and/or the like. The call features may include features identifying call locations, numbers associated with calls, quantities of calls per time period, average call times, total call times, long distance calls, calls from caller identifications, whether calls are transcribed, and/or the like.

The identification proof features may include features identifying extracted addresses of the plurality of users, bills associated with the plurality of users, locations associate with the plurality of users, device usage associated with the plurality of users, and/or the like. The call or chat transcripts may include features identifying textual transcripts of the call features and/or the text features, intents of the call or chat transcripts, sentiments of the call or chat transcripts, and/or the like. The transaction features may include features identifying transactions conducted by the plurality of users. The device features may include features identifying new devices, verified devices, devices utilized in billing locations, devices utilized in physical add locations, devices associated with email features or text features, devices deactivated within a time period, and/or the like. The account features may include features identifying accounts of the plurality of users, purchase orders of the accounts, values of purchases in the accounts whether the accounts are business accounts, whether billing and account addresses are the same, billing addresses of the accounts, quantity of items ordered via the accounts, owners of the accounts, changes to the accounts, high risk accounts, high risk transactions of the accounts, bill deviations for the accounts, and/or the like.

The data structure 110 may provide the input data identifying the input features associated with the plurality of users of the network to the security system 105, and the security system 105 may receive the input data from the data structure 110. In some implementations, the security system 105 may continuously receive the input data from the data structure 110, may periodically receive the input data from the data structure 110, may receive the input data from the data structure 110 based on requesting the input data from the data structure 110, and/or the like.

As further shown in FIG. 1A, and by reference number 120, the security system 105 may process the input data for a user, with an initial model, to predict one or more fraud stages for the user. For example, the security system 105 may analyze the input data for a user of the plurality of users to determine whether the user is associated with fraudulent activities. The security system 105 may be associated with an initial model that is a machine learning model, such as a neural network model with an embedding layer, long short-term memory (LSTM) layers, a dense layer, and/or the like. The security system 105 may utilize the initial model to determine one or more fraud stages for the user based on the input data. For example, the user may be associated with a first fraud stage indicating identity theft of the user; a second fraud stage indicating an account takeover for the user (e.g., based on updated account information); a third fraud stage indicating fraud associated with adding and/or updating services and/or accounts of the user, subscriber identity module (SIM) swapping, unapproved purchase of devices, adding a new customer without user authorization, illegitimate accessing of user accounts or performance of transactions, the user being unable to access an account, etc.; and/or the like. In some implementations, the user may be associated with one or more of the first fraud stage, the second fraud stage, the third fraud stage, and/or the like.

As shown in FIG. 1B, and by reference number 125, the security system 105 may identify one or more sets of models from a plurality of models and based on the one or more fraud stages. For example, the security system 105 may be associated with a plurality of fraud detection models that are machine learning models, such as neural network models with embedding layers, LSTM layers, dense layers, and/or the like. Certain models of the plurality of models may be tailored to different types of fraud detection and may be more appropriate for detecting fraud associated with the one or more fraud stages. The security system 105 may analyze the one or more fraud stages and may determine the one or more sets of models, from the plurality of models, based on analyzing the one or more fraud stages. For example, the security system 105 may include, in a set of models, a model that calculates an identity theft score for the user when the one or more fraud stages include the first fraud stage. In another example, the security system 105 may include, in a set of models, a model that calculates a risk score for the user, a model that calculates a fraud pattern for the user, a model that calculates a credit impact risk score for the user, and/or a model that calculate a next action of the user when the one or more fraud stages include the first fraud stage, the second fraud stage, and the third fraud stage. In still another example, the security system 105 may include, in a set of models, a model that calculates a bill impact value for the user when the one or more fraud stages include the first fraud stage and the second fraud stage. In another example, the security system 105 may include, in a set of models, a model that calculates an impact type for the user when the one or more fraud stages include the second fraud stage and the third fraud stage.

As shown in FIG. 1C, and by reference number 130, the security system 105 may process the input data for the user, with the one or more sets of models, to determine one or more fraud parameters associated with the user. For example, the security system 105 may utilize the one or more sets of models to determine the one more fraud patterns associated with the user and based on the input data. In some implementations, when processing the input data, with the one or more sets of models, to determine the one or more fraud parameters, the security system 105 may sequentially process the input data, with the one or more sets of models, to determine the one or more fraud parameters associated with the user, or may process the input data, in parallel with the one or more sets of models, to determine the one or more fraud parameters associated with the user.

In some implementations, when processing the input data, with the one or more sets of models, to determine the one or more fraud parameters, the security system 105 may process the input data, with the one or more sets of models, to determine an identity theft score associated with the user; may process the input data, with the one or more sets of models, to determine a risk score associated with the user; may process the input data, with the one or more sets of models, to determine a fraud pattern associated with the user; may process the input data, with the one or more sets of models, to determine a credit impact risk associated with the user; may process the input data, with the one or more sets of models, to determine a bill impact score associated with the user; may process the input data, with the one or more sets of models, to determine a next action of the user; may process the input data, with the one or more sets of models, to determine an impact type associated with the user; and/or the like. In such implementations, the fraud parameters may correspond to the identity theft score associated with the user, the risk score associated with the user, the fraud pattern associated with the user, the credit impact risk associated with the user, the bill impact score associated with the user, the next action of the user, the impact type associated with the user, and/or the like.

As shown in FIG. 1D, and by reference number 135, the security system 105 may identify a fraudulent activity associated with the user based on the fraud parameters. For example, the security system 105 may determine, based on the fraud parameters, that a bad actor other than the user is performing the fraudulent activity. In such implementations, the fraudulent activity may include the bad actor performing identity theft of the user, the bad actor taking over an account of the user, the bad actor impermissibly updating account information of the user, the bad actor adding and/or updating services associated with accounts of the user, the bad actor impermissibly performing a SIM swap associated with a device of the user, the bad actor impermissibly purchasing a device via an account of the user, the bad actor creating a new customer profile for the bad actor and via an account of the user, the bad actor impermissibly accessing a financial account of the user, the bad actor impermissibly performing a transaction via a financial account of the user, and/or the like.

Alternatively, the security system 105 may determine, based on the fraud parameters, that the user is performing the fraudulent activity. In such implementations, the fraudulent activity may include the user performing identity theft of another user, the user taking over an account of another user, the user impermissibly updating account information of another user, the user adding and/or updating services associated with accounts of another user, the user impermissibly performing a SIM swap associated with a device of another user, the user impermissibly purchasing a device via an account of another user, the user creating a new customer profile for the user and via an account of another user, the user impermissibly accessing a financial account of another user, the user impermissibly performing a transaction via a financial account of another user, and/or the like.

As shown in FIG. 1E, and by reference number 140, the security system 105 may utilize a large language model to generate steps to resolve the fraudulent activity based on historical fraud resolutions. For example, the security system 105 may be associated with a large language model. The large language model may have access to a data structure that includes historical fraud resolutions generated for historical fraudulent activities. The large language model may receive the historical fraud resolutions from the data structure, and may process the fraudulent activity and the historical fraud resolutions to generate the steps to resolve the fraudulent activity. In some implementations, the large language model may compare the fraudulent activity and the historical fraudulent activities to determine one of the historical fraudulent activities that is most similar to the fraudulent activity. The large language model may identify one of the historical fraud resolutions that corresponds to the one of the historical fraudulent activities. The large language model utilizes the historical steps utilizing in the one of the historical fraud resolutions to generate the steps to resolve the fraudulent activity. In one example, the steps to resolve the fraudulent activity may include updating credentials and access of the user (e.g., when the fraudulent activity is associated with the first fraud stage); updating credentials and access of the user and reviewing an account of the user (e.g., when the fraudulent activity is associated with the second fraud stage); reviewing an order of the user, a pick up location of the user, and device options of the user (e.g., when the fraudulent activity is associated with the second fraud stage); causing the user to immediately contact a fraud department (e.g., when the fraudulent activity is associated with the third fraud stage); and/or the like.

As further shown in FIG. 1E, and by reference number 145, the security system 105 may provide the steps to resolve the fraudulent activity to a representative for implementation. For example, the security system 105 may provide the steps to resolve the fraudulent activity to a user device of a representative that is providing assistance to the user. The user device may display the steps to resolve the fraudulent activity to the representative, and the representative may perform the actions indicated by the steps to resolve the fraudulent activity. In some implementations, when the user is a bad actor, the representative may not provide assistance to the user. Alternatively, the security system 105 may provide the steps to resolve the fraudulent activity to a user device associated with the user (e.g., when the user is not a bad actor). The user device may display the steps to resolve the fraudulent activity to the user, and the user may perform the actions indicated by the steps to resolve the fraudulent activity. In some implementations, the steps to resolve the fraudulent activity may include bullet points or a flowchart designed to help the representative mitigate the fraudulent activity.

As shown in FIG. 1F, and by reference number 150, the security system 105 may perform one or more actions based on the fraudulent activity. In some implementations, performing the one or more actions includes the security system 105 providing a notification of the fraudulent activity to a representative or a law enforcement agency. For example, the security system 105 may generate a notification of the fraudulent activity, and may provide the notification to a user device associated with a representative or a law enforcement agency. The user device may display the notification to the representative or the law enforcement agency, and the representative or the law enforcement agency may take appropriate steps to mitigate the fraudulent activity. In some implementations, the notification may include a dashboard indicating the fraudulent activity (e.g., with a risk meter or score), a numerical or graphical representation of the fraudulent activity, a notification pop-up or alert symbol, and/or the like. In this way, the security system 105 conserves computing resources, networking resources, and/or other resources that would have otherwise been consumed by failing accurately identify fraudulent activities.

In some implementations, performing the one or more actions includes the security system 105 verifying an identify of the user using biometric data to prevent the fraudulent activity. For example, based on the fraudulent activity, the security system 105 may verify the user to prevent the fraudulent activity. In some implementations, the security system 105 may utilize a fingerprint scan or a facial recognition process for biometric verification of the user, may utilize a verification screen requiring additional user input, such as a security question or a one-time password entry, and/or the like. In this way, the security system 105 conserves computing resources, networking resources, and/or other resources that would have otherwise been consumed by failing to timely identify fraudulent activities.

In some implementations, performing the one or more actions includes the security system 105 preventing a transaction associated with the fraudulent activity. For example, the security system 105 may identify the fraudulent activity as an impermissible transaction associated with an account of the user. The security system 105 may provide, to a user device of the user, a user interface indicating the transaction as being blocked, to represent that the transaction is being prevented. The user device may display the user interface to the user, and the user may be assured that the fraudulent transaction has been appropriately handled. In this way, the security system 105 conserves computing resources, networking resources, and/or other resources that would have otherwise been consumed by handling increased customer complaints due to fraudulent activities.

In some implementations, performing the one or more actions includes the security system 105 modifying the one or more fraud parameters based on the fraudulent activity. For example, if the fraudulent activity is a new type of activity, the security system 105 may update the fraud parameters to include the fraudulent activity so that the fraudulent activity may be identified in the future. In this way, the security system 105 conserves computing resources, networking resources, and/or other resources that would have otherwise been consumed by handling increased operational costs due to fraudulent activities.

In some implementations, performing the one or more actions includes the security system 105 initiating a secondary verification process for a transaction based on the fraudulent activity. For example, based on the fraudulent activity, the security system 105 may verify the user to prevent the fraudulent activity. In some implementations, the security system 105 may utilize a verification screen requiring additional user input, such as a security question, a two-factor authentication, or a one-time password entry, and/or the like. In this way, the security system 105 conserves computing resources, networking resources, and/or other resources that would have otherwise been consumed by failing to timely identify fraudulent activities.

In some implementations, performing the one or more actions includes the security system 105 retraining one or more of the plurality of models based on the fraudulent activity. For example, the security system 105 may utilize the fraudulent activity as additional training data for retraining the one or more of the plurality of models, thereby increasing the quantity of training data available for training the one or more of the plurality of models. Accordingly, the security system 105 may conserve computing resources associated with training the one or more of the plurality of models, failing accurately identify fraudulent activities, failing to timely identify fraudulent activities, handling increased customer complaints due to fraudulent activities, handling increased operational costs due to fraudulent activities, losing customers due to fraudulent activities, and/or the like.

In some implementations, the security system 105 may perform one or more other actions, such as generating a fraud alert based on the fraudulent activity, and providing the fraud alert to the user via a communication channel (e.g., a text message, an email message, and/or the like); receiving data identifying new fraud tactics, and retraining one or more of the plurality of models based on the data identifying the new fraud tactics; and/or the like.

FIG. 1G depicts an example overview of the set of models of the security system 105. As shown in FIG. 1G, initial model may predict a customer stage based on the input features. If the first stage or the second stage is predicted, the security system 105 may trigger for every transaction or account update and may provide guidance to the customer. A first model may predict an identity theft score when the first stage is predicted by the initial model, and a second model may predict a risk score (e.g., a risk probability of the customer) when the first, second, and third stages are predicted by the initial model. After utilizing a rule extraction model, the third model may derive a fraud pattern (e.g., fraud pattern for identified customer with identity theft) when the first, second, and third stages are predicted by the initial model. After utilizing a forecasting mode, a fourth model may forecast a bill impact value (e.g., forecast a possible loss of value to the customer due to identified fraud activity or an actual bill impact amount) when the first and second stages are predicted by the initial model. A fifth model may predict a credit impact risk score (e.g., risk probability of the customer) when the first, second, and third stages are predicted by the initial model. A sixth model may predict a next action (e.g., next action of a bad actor) when the first, second, and third stages are predicted by the initial model, and a seventh model may predict an impact type when the first and second stages are predicted by the initial model.

FIG. 1H depicts an example fradulent transaction handled by the security system 105. As shown, the initial model may predict a customer stage based on input features, such as a first stage, a second stage, or a third stage. A first model may predict an identity theft score of 0.91, a second model may predict a risk score of 0.85 or 0.95, a third model may derive fraud patterns, a fourth model may forecast a bill impact value of $XXXX or $YYYY, a fifth model may predict a credit impact risk score of 0.81 or 0.85, a sixth model may predict a next action of a device in-store pickup by unauthorized user or an already completed fraud transaction, and a seventh model may determine an impact type of purchase or order. Based on the predictions of the models, the security system 105 may generate an LLM resolution, such as update credentials and access for the first stage, update credentials and access and review an account for the second stage, review an order, pickup locations and options for the second stage, and reach fraud department immediately for the third stage.

In this way, the security system 105 utilizes AI models to prevent fraudulent activities. For example, the security system 105 may enhance and expedite detection and resolution of fraudulent activities using advanced analytical models (e.g., AI models, machine learning models, and/or the like). The security system 105 significantly improves upon current techniques for preventing fraudulent activities by automating the detection of fraudulent activities through utilization of the analytical models. By reducing reliance on manual intervention and accelerating response time to identify and prevent fraudulent activities, the security system 105 may mitigate losses due to fraudulent activities more effectively, may reduce costs, and may enhance the operational integrities of technological environments operated by businesses. Thus, the security system may conserve computing resources, networking resources, and/or other resources that would have otherwise been consumed by failing accurately identify fraudulent activities, failing to timely identify fraudulent activities, handling increased customer complaints due to fraudulent activities, handling increased operational costs due to fraudulent activities, losing customers due to fraudulent activities, and/or the like.

As indicated above, FIGS. 1A-1H are provided as an example. Other examples may differ from what is described with regard to FIGS. 1A-1H. The number and arrangement of devices shown in FIGS. 1A-1H are provided as an example. In practice, there may be additional devices, fewer devices, different devices, or differently arranged devices than those shown in FIGS. 1A-1H. Furthermore, two or more devices shown in FIGS. 1A-1H may be implemented within a single device, or a single device shown in FIGS. 1A-1H may be implemented as multiple, distributed devices. Additionally, or alternatively, a set of devices (e.g., one or more devices) shown in FIGS. 1A-1H may perform one or more functions described as being performed by another set of devices shown in FIGS. 1A-1H.

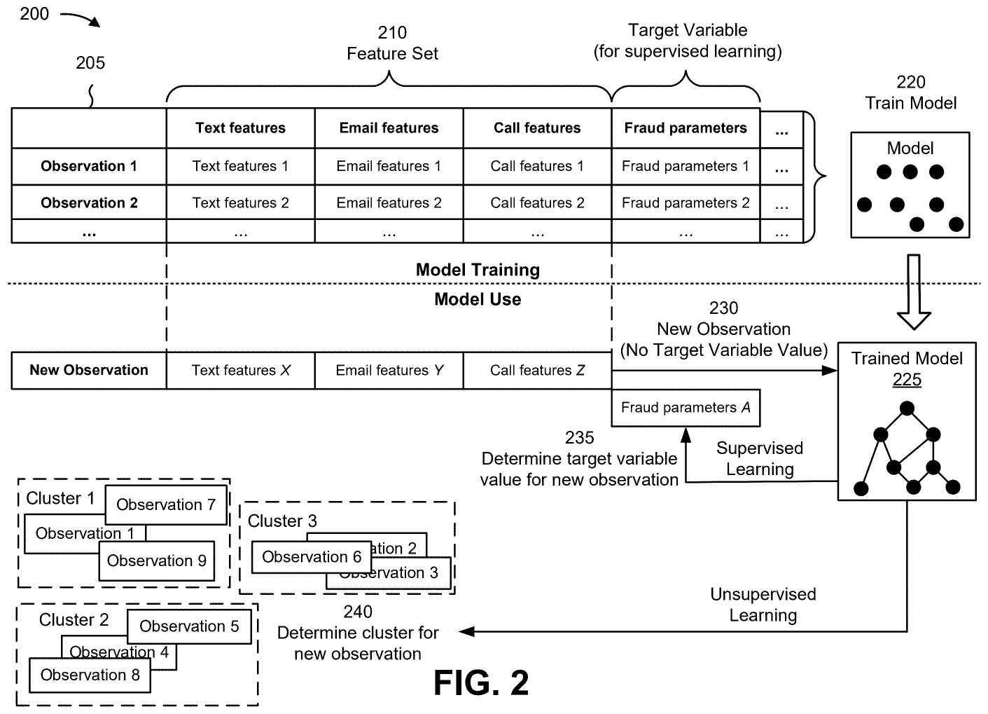

FIG. 2 is a diagram illustrating an example 200 of training and using a machine learning model. The machine learning model training and usage described herein may be performed using a machine learning system. The machine learning system may include or may be included in a computing device, a server, a cloud computing environment, or the like, such as the security system 105.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input) from the security system 105, as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the security system 105. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of text features, a second feature of email features, a third feature of call features, and so on. As shown, for a first observation, the first feature may have a value of text features 1, the second feature may have a value of email features 1, the third feature may have a value of call features 1, and so on. These features and feature values are provided as examples, and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is fraud parameters, which has a value of fraud parameters 1 for the first observation. The feature set and target variable described above are provided as examples, and other examples may differ from what is described above.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of text features X, a second feature of email features Y, a third feature of call features Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of fraud parameters A for the target variable of fraud parameters for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a text features cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., an email features cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model).

In this way, the machine learning system may apply a rigorous and automated process to prevent fraudulent activities. The machine learning system may enable recognition and/or identification of tens, hundreds, thousands, or millions of features and/or feature values for tens, hundreds, thousands, or millions of observations, thereby increasing accuracy and consistency and reducing delay associated with preventing fraudulent activities relative to requiring computing resources to be allocated for tens, hundreds, or thousands of operators to manually prevent fraudulent activities.

As indicated above, FIG. 2 is provided as an example. Other examples may differ from what is described in connection with FIG. 2.

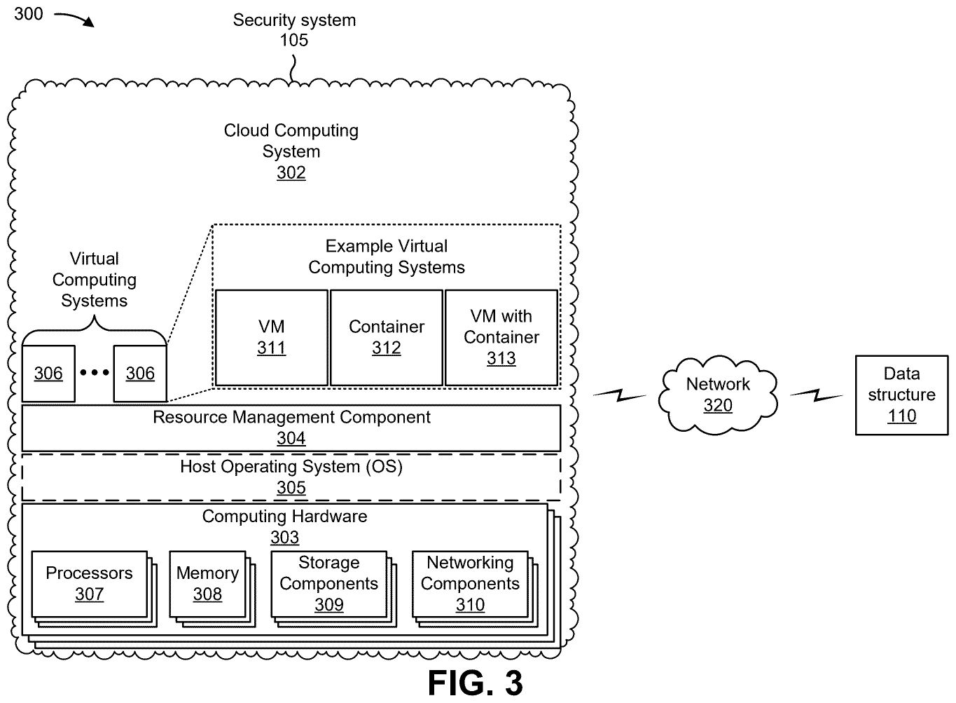

FIG. 3 is a diagram of an example environment 300 in which systems and/or methods described herein may be implemented. As shown in FIG. 3, the environment 300 may include the security system 105, which may include one or more elements of and/or may execute within a cloud computing system 302. The cloud computing system 302 may include one or more elements 303-313, as described in more detail below. As further shown in FIG. 3, the environment 300 may include the data structure 110 and/or a network 320. Devices and/or elements of the environment 300 may interconnect via wired connections and/or wireless connections.

The data structure 110 may include one or more devices capable of receiving, generating, storing, processing, and/or providing information, as described elsewhere herein. The data structure 110 may include a communication device and/or a computing device. For example, the data structure 110 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 110 may communicate with one or more other devices of environment 300, as described elsewhere herein.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

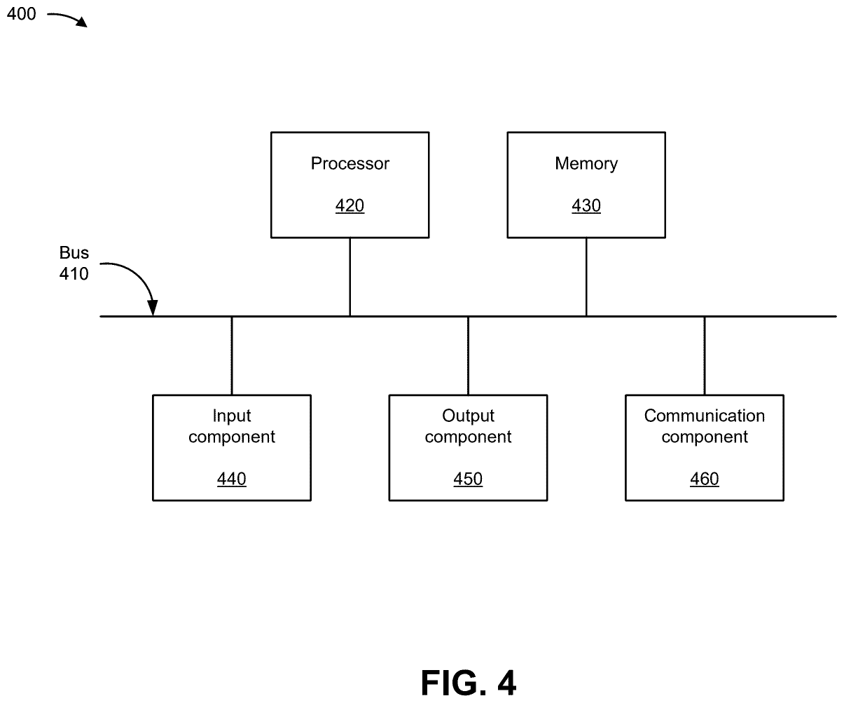

Although the security system 105 may include one or more elements 303-313 of the cloud computing system 302, may execute within the cloud computing system 302, and/or may be hosted within the cloud computing system 302, in some implementations, the security system 105 may not be cloud-based (e.g., may be implemented outside of a cloud computing system) or may be partially cloud-based. For example, the security system 105 may include one or more devices that are not part of the cloud computing system 302, such as a device 400 of FIG. 4, which may include a standalone server or another type of computing device. The security system 105 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the security system 105 and/or the data structure 110. In some implementations, the security system 105 and/or the data structure 110 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

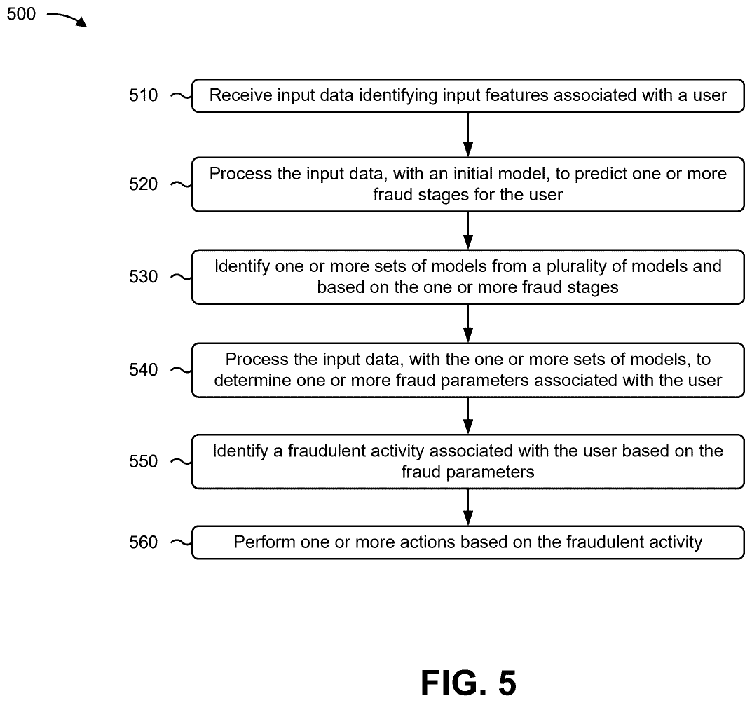

FIG. 5 depicts a flowchart of an example process 500 for utilizing AI models to prevent fraudulent activities. In some implementations, one or more process blocks of FIG. 5 may be performed by a device (e.g., the security system 105). In some implementations, one or more process blocks of FIG. 5 may be performed by another device or a group of devices separate from or including the device. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving input data identifying input features associated with a user (block 510). For example, the device may receive input data identifying input features associated with a user, as described above. In some implementations, the input data includes data identifying one or more of one or more text features associated with the user, one or more email features associated with the user, one or more call features associated with the user, one or more identification proof features associated with the user, one or more call or chat transcripts associated with the user, one or more transaction features associated with the user, one or more device features associated with the user, or one or more account features associated with the user.

As further shown in FIG. 5, process 500 may include processing the input data, with an initial model, to predict one or more fraud stages for the user (block 520). For example, the device may process the input data, with an initial model, to predict one or more fraud stages for the user, as described above. In some implementations, the one or more fraud stages for the user include one or more of a fraud stage associated with identity theft of the user, a fraud stage associated with a takeover of an account of the user, a fraud stage associated with an added or updated service or account of the user, a fraud stage associated with swapping a subscriber identity module of the user, a fraud stage associated with purchasing a device, a fraud stage associated with adding a new customer associated with the user, a fraud stage associated with a transaction at a financial institution of the user, or a fraud stage associated with the user being unable to access an account.

As further shown in FIG. 5, process 500 may include identifying one or more sets of models from a plurality of models and based on the one or more fraud stages (block 530). For example, the device may identify one or more sets of models from a plurality of models and based on the one or more fraud stages, as described above. In some implementations, identifying the one or more sets of models from the plurality of models and based on the one or more fraud stages includes identifying, from the plurality of models, a set of models for each of the one or more fraud stages.

As further shown in FIG. 5, process 500 may include processing the input data, with the one or more sets of models, to determine one or more fraud parameters associated with the user (block 540). For example, the device may process the input data, with the one or more sets of models, to determine one or more fraud parameters associated with the user, as described above. In some implementations, processing the input data, with the one or more sets of models, to determine the one or more fraud parameters associated with the user includes one of sequentially processing the input data, with the one or more sets of models, to determine the one or more fraud parameters associated with the user, or processing the input data, in parallel with the one or more sets of models, to determine the one or more fraud parameters associated with the user.

In some implementations, processing the input data, with the one or more sets of models, to determine the one or more fraud parameters associated with the user includes one or more of processing the input data, with the one or more sets of models, to determine an identity theft score associated with the user; processing the input data, with the one or more sets of models, to determine a risk score associated with the user; processing the input data, with the one or more sets of models, to determine a fraud pattern associated with the user; processing the input data, with the one or more sets of models, to determine a credit impact risk associated with the user; processing the input data, with the one or more sets of models, to determine a bill impact score associated with the user; processing the input data, with the one or more sets of models, to determine a next action of the user; or processing the input data, with the one or more sets of models, to determine an impact type associated with the user.

As further shown in FIG. 5, process 500 may include identifying a fraudulent activity associated with the user based on the fraud parameters (block 550). For example, the device may identify a fraudulent activity associated with the user based on the fraud parameters, as described above.

As further shown in FIG. 5, process 500 may include performing one or more actions based on the fraudulent activity (block 560). For example, the device may perform one or more actions based on the fraudulent activity, as described above. In some implementations, performing the one or more actions includes one or more of providing a notification of the fraudulent activity to a representative or a law enforcement agency, or verifying an identify of the user using biometric data to prevent the fraudulent activity. In some implementations, performing the one or more actions includes one or more of preventing a transaction associated with the fraudulent activity, or modifying the one or more fraud parameters based on the fraudulent activity. In some implementations, performing the one or more actions includes one or more of initiating a secondary verification process for a transaction based on the fraudulent activity, or retraining one or more of the plurality of models based on the fraudulent activity. In some implementations, performing the one or more actions includes generating a fraud alert based on the fraudulent activity, and providing the fraud alert to the user via a communication channel.

In some implementations, process 500 includes comparing the input data and historical fraud data to generate a modification for the fraudulent activity, and modifying fraudulent activity based on the modification. In some implementations, process 500 includes utilizing a large language model to generate steps to resolve the fraudulent activity based on historical fraud resolutions, and providing the steps to resolve the fraudulent activity to a representative for implementation. In some implementations, process 500 includes receiving data identifying new fraud tactics, and retraining one or more of the plurality of models based on the data identifying the new fraud tactics.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of”' a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, input data identifying input features associated with a user;
processing, by the device, the input data, with an initial model, to predict one or more fraud stages for the user;
identifying, by the device, one or more sets of models from a plurality of models and based on the one or more fraud stages;
processing, by the device, the input data, with the one or more sets of models, to determine one or more fraud parameters associated with the user;
identifying, by the device, a fraudulent activity associated with the user based on the fraud parameters; and
performing, by the device, one or more actions based on the fraudulent activity.

2. The method of claim 1, further comprising:
comparing the input data and historical fraud data to generate a modification for the fraudulent activity; and
modify fraudulent activity based on the modification.

3. The method of claim 1, wherein the input data includes data identifying one or more of:
one or more text features associated with the user,
one or more email features associated with the user,
one or more call features associated with the user,
one or more identification proof features associated with the user,
one or more call or chat transcripts associated with the user,
one or more transaction features associated with the user,
one or more device features associated with the user, or
one or more account features associated with the user.

4. The method of claim 1, wherein the one or more fraud stages for the user include one or more of:
a fraud stage associated with identity theft of the user,
a fraud stage associated with a takeover of an account of the user,
a fraud stage associated with an added or updated service or account of the user,
a fraud stage associated with swapping a subscriber identity module of the user,
a fraud stage associated with purchasing a device,
a fraud stage associated with adding a new customer associated with the user,
a fraud stage associated with a transaction at a financial institution of the user, or
a fraud stage associated with the user being unable to access an account.

5. The method of claim 1, wherein identifying the one or more sets of models from the plurality of models and based on the one or more fraud stages comprises:
identifying, from the plurality of models, a set of models for each of the one or more fraud stages.

6. The method of claim 1, wherein processing the input data, with the one or more sets of models, to determine the one or more fraud parameters associated with the user comprises one of:
sequentially processing the input data, with the one or more sets of models, to determine the one or more fraud parameters associated with the user; or
processing the input data, in parallel with the one or more sets of models, to determine the one or more fraud parameters associated with the user.

7. The method of claim 1, wherein processing the input data, with the one or more sets of models, to determine the one or more fraud parameters associated with the user comprises one or more of:
processing the input data, with the one or more sets of models, to determine an identity theft score associated with the user;
processing the input data, with the one or more sets of models, to determine a risk score associated with the user;
processing the input data, with the one or more sets of models, to determine a fraud pattern associated with the user;
processing the input data, with the one or more sets of models, to determine a credit impact risk associated with the user;
processing the input data, with the one or more sets of models, to determine a bill impact score associated with the user;
processing the input data, with the one or more sets of models, to determine a next action of the user; or
processing the input data, with the one or more sets of models, to determine an impact type associated with the user.

8. A device, comprising:
one or more processors configured to:
receive input data identifying input features associated with a user;
process the input data, with an initial model, to predict one or more fraud stages for the user;
identify one or more sets of models from a plurality of models and based on the one or more fraud stages;
process the input data, with the one or more sets of models, to determine one or more fraud parameters associated with the user,
wherein the fraud parameters include one or more of:
an identity theft score associated with the user,
a risk score associated with the user,
a fraud pattern associated with the user,
a credit impact risk associated with the user,
a bill impact score associated with the user,
a next action of the user, or
an impact type associated with the user;
identify a fraudulent activity associated with the user based on the fraud parameters; and
perform one or more actions based on the fraudulent activity.

9. The device of claim 8, wherein the one or more processors, to perform the one or more actions, are configured to:
utilize a large language model to generate steps to resolve the fraudulent activity based on historical fraud resolutions; and
provide the steps to resolve the fraudulent activity to a representative for implementation.

10. The device of claim 8, wherein the one or more processors, to perform the one or more actions, are configured to one or more of:
provide a notification of the fraudulent activity to a representative or a law enforcement agency; or
verify an identify of the user using biometric data to prevent the fraudulent activity.

11. The device of claim 8, wherein the one or more processors, to perform the one or more actions, are configured to one or more of:
prevent a transaction associated with the fraudulent activity; or
modify the one or more fraud parameters based on the fraudulent activity.

12. The device of claim 8, wherein the one or more processors, to perform the one or more actions, are configured to one or more of:
initiate a secondary verification process for a transaction based on the fraudulent activity; or
retrain one or more of the plurality of models based on the fraudulent activity.

13. The device of claim 8, wherein the one or more processors, to perform the one or more actions, are configured to:
generate a fraud alert based on the fraudulent activity; and
provide the fraud alert to the user via a communication channel.

14. The device of claim 8, wherein the one or more processors are further configured to:
receive data identifying new fraud tactics; and
retrain one or more of the plurality of models based on the data identifying the new fraud tactics.

15. A non-transitory computer-readable medium storing a set of instructions, the set of instructions comprising:
one or more instructions that, when executed by one or more processors of a device, cause the device to:
receive input data identifying input features associated with a user;
process the input data, with an initial model, to predict one or more fraud stages for the user;
identify one or more sets of models from a plurality of models and based on the one or more fraud stages;
process the input data, with the one or more sets of models, to determine one or more fraud parameters associated with the user;
identify a fraudulent activity associated with the user based on the fraud parameters;
utilize a large language model to generate steps to resolve the fraudulent activity based on historical fraud resolutions; and
provide the steps to resolve the fraudulent activity to a representative or the user for implementation.

16. The non-transitory computer-readable medium of claim 15, wherein the one or more instructions further cause the device to:
compare the input data and historical fraud data to generate a modification for the fraudulent activity; and
modify fraudulent activity based on the modification.

17. The non-transitory computer-readable medium of claim 15, wherein the one or more instructions, that cause the device to process the input data, with the one or more sets of models, to determine the one or more fraud parameters associated with the user, cause the device to:
sequentially process the input data, with the one or more sets of models, to determine the one or more fraud parameters associated with the user; or
process the input data, in parallel with the one or more sets of models, to determine the one or more fraud parameters associated with the user.

18. The non-transitory computer-readable medium of claim 15, wherein the one or more instructions, that cause the device to process the input data, with the one or more sets of models, to determine the one or more fraud parameters associated with the user, cause the device to one or more of:
process the input data, with the one or more sets of models, to determine an identity theft score associated with the user;
process the input data, with the one or more sets of models, to determine a risk score associated with the user;
process the input data, with the one or more sets of models, to determine a fraud pattern associated with the user;
process the input data, with the one or more sets of models, to determine a credit impact risk associated with the user;
process the input data, with the one or more sets of models, to determine a bill impact score associated with the user;
process the input data, with the one or more sets of models, to determine a next action of the user; or
process the input data, with the one or more sets of models, to determine an impact type associated with the user.

19. The non-transitory computer-readable medium of claim 15, wherein the one or more instructions further cause the device to one or more of:
provide a notification of the fraudulent activity to a representative or a law enforcement agency;
verify an identify of the user using biometric data to prevent the fraudulent activity; or
prevent a transaction associated with the fraudulent activity.

20. The non-transitory computer-readable medium of claim 15, wherein the one or more instructions further cause the device to one or more of:
modify the one or more fraud parameters based on the fraudulent activity;
initiate a secondary verification process for a transaction based on the fraudulent activity;
retrain one or more of the plurality of models based on the fraudulent activity; or
generate a fraud alert based on the fraudulent activity.
